(19) United States
(12) Patent Application Publication
(10) Pub. No.: US 2008/0320217 A1
(43) Pub. Date: Dec. 25, 2008

(54) Executing I/O Requests For A Disk Drive

(76) Inventor: Frank E. Levine, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/767,146

(22) Filed: Jun. 22, 2007

(51) Int. Cl. G06F 12/00

(52) U.S. Cl. 711/112

(57) ABSTRACT

Executing I/O requests for a disk drive including receiving, by a device driver from a volume manager, a plurality of I/O requests; retrieving, from non-volatile memory by the device driver, information describing access times for storage locations on the disk drive; and executing, by the device driver, the I/O requests in a sequence, including identifying, in dependence upon the information describing access times for storage locations on the disk drive, the sequence for executing the I/O requests.

### BACKGROUND OF THE INVENTION

1. Field of the Invention

The field of the invention is data processing, or, more specifically, methods, apparatus, and products for executing input/output (‘I/O’) requests for a disk drive.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in executing I/O requests for a disk drive. A disk drive device driver typically receive many I/O requests, each I/O request indicated a physical location on the disk drive to access. Due to seek time, settle time, and rotational latency present when executing any I/O request, executing the I/O requests in the order in which the requests were received is typically not efficient.

### SUMMARY OF THE INVENTION

Methods, apparatus, and products for executing I/O requests for a disk drive are disclosed, that include receiving, by a device driver from a volume manager, a plurality of I/O requests; retrieving, from non-volatile memory by the device driver, information describing access times for storage locations on the disk drive; and executing, by the device driver, the I/O requests in a sequence, including identifying, in dependence upon the information describing access times for storage locations on the disk drive, the sequence for executing the I/O requests.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in executing I/O requests for a disk drive according to embodiments of the present invention.

FIG. 2 sets forth a flow chart illustrating an exemplary method for executing I/O requests for a disk drive according to embodiments of the present invention.

FIG. 3 sets forth a flow chart illustrating a further exemplary method for executing I/O requests for a disk drive according to embodiments of the present invention.

FIG. 4 sets forth a flow chart illustrating a further exemplary method for executing I/O requests for a disk drive according to embodiments of the present invention.

FIG. 5 sets forth a flow chart illustrating a further exemplary method for executing I/O requests for a disk drive according to embodiments of the present invention.

### DETAILED DESCRIPTION OF EXEMPLARY EMBODIMENTS

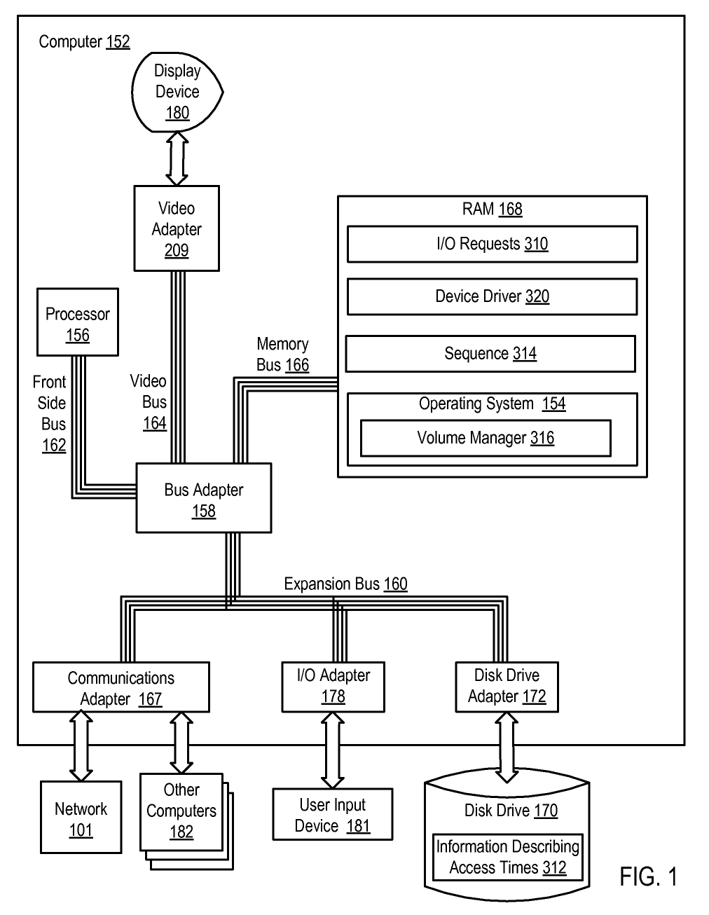

Exemplary methods, apparatus, and products for executing I/O requests for a disk drive in accordance with the present invention are described with reference to the accompanying drawings, beginning with FIG. 1. Executing I/O requests for a disk drive in accordance with embodiments of the present invention is generally implemented with computers, that is, with automated computing machinery. For explanation, therefore, FIG. 1 sets forth a block diagram of automated computing machinery comprising an exemplary computer (152) useful in executing I/O requests for a disk drive according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) is device driver (320), a module of computer program instructions that executes I/O requests for the disk drive (170) in accordance with embodiments of the present invention by receiving, from a volume manager (316), a plurality of I/O requests (310). The exemplary device driver (320) of FIG. 1 also retrieves, from non-volatile memory, such as disk drive (170), information (312) describing access times for storage locations on the disk drive. The exemplary device driver (320) of FIG. 1 also executes the I/O requests (310) in a sequence, including identifying, in dependence upon the information (312) describing access times for storage locations on the disk drive, the sequence (314) for executing the I/O requests. Also stored in RAM (168) of the exemplary computer (152) is an operating system (154). Operating systems useful in computers according to embodiments of the present invention include UNIX™, Linux™, Microsoft Vista™, Microsoft XP™, AIX™, IBM's i5/OS™, and others as will occur to those of skill in the art. Operating system (154) and the volume manager (316) in the example of FIG. 1 are shown in RAM (168), but many components of such software typically are stored in non-volatile memory also, for example, on a disk drive (170).

The computer (152) of FIG. 1 includes a bus adapter (158), a computer hardware component that contains drive electronics for the high speed buses, the front side bus (162), the video bus (164), and the memory bus (166), as well as drive electronics for the slower expansion bus (160). Examples of bus adapters useful for executing I/O requests for a disk drive according to embodiments of the present invention include the Intel Northbridge, the Intel Memory Controller Hub, the Intel Southbridge, and the Intel I/O Controller Hub. Examples of expansion buses useful for executing I/O requests for a disk drive according to embodiments of the present invention include Industry Standard Architecture (‘ISA’) buses and Peripheral Component Interconnect (‘PCI’) buses.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (101). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for executing I/O requests for a disk drive according to embodiments of the present invention include modems for wired dial-up communications, Ethernet (IEEE 802.3) adapters for wired data communications network communications, and 802.11 adapters for wireless data communications network communications.

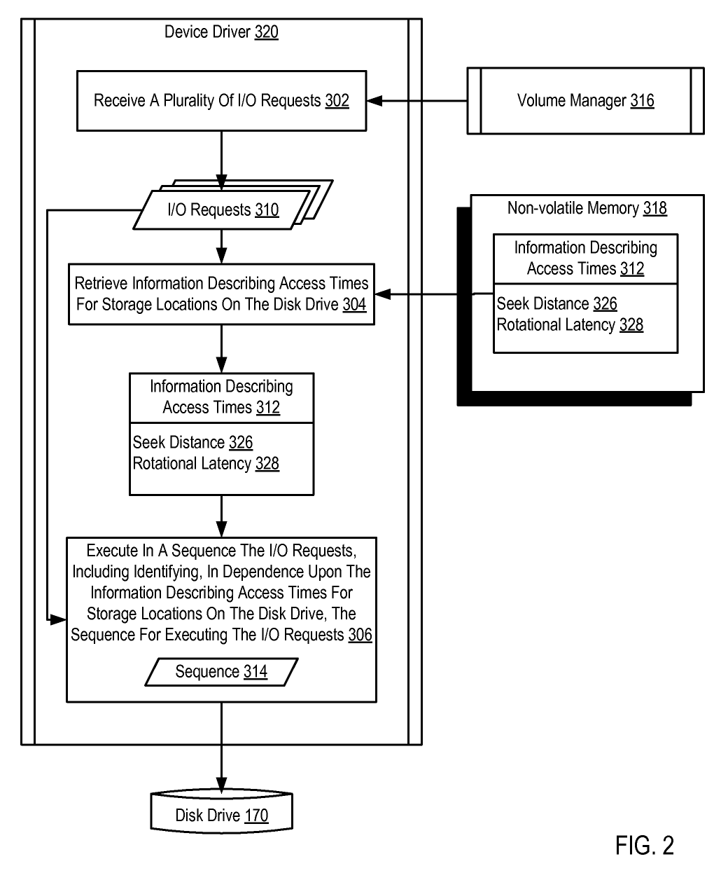

For further explanation, FIG. 2 sets forth a flow chart illustrating an exemplary method for executing I/O requests for a disk drive according to embodiments of the present invention. The method of FIG. 2 is implemented by a device driver (320). A device driver is module of computer program instructions that allow software programs to interact with computer hardware. That is, a driver is an interface for communication with a hardware device. The method of FIG. 2 includes receiving (302), by the device driver (320) from a volume manager (316), a plurality of I/O requests (310). An I/O request is a request to read or write from or to a disk drive. I/O requests executed in accordance with embodiments of the present invention may include an identification of a cylinder, a disk drive head, and a disk drive sector. That is, an I/O request may include an identification of an actual physical location on the disk drive. A disk drive comprises a plurality of platters. Each platter is divided into concentric, circular tracks and each track is divided into sectors. A cylinder represents a collection of tracks aligned through the stack of platters on a disk drive. The number of cylinders of a disk drive, then, exactly equals the number of tracks on a single platter in the drive. Data is written to and read from the surface of a platter by a device called a disk drive head. Each platter has two sides and two heads, one for writing to and reading from each side of the platter. An I/O request identifying a cylinder, a head, and a sector, then, uniquely identifies a sector of a track on one side of a platter, an actual physical location on the disk drive. In another embodiment, a sector is addressed using a Relative Block Address (‘RBA’) or a Logical Block Address (‘LBA’).

In the method of FIG. 2, the exemplary device driver (320) receives I/O requests from a volume manager. A volume manager is a module of computer program instructions that allocates space on a disk drive and presents the disk drive as a collection of virtual partitions. Volume managers receive requests from software applications to read and write data from and to a disk drive. These requests typically include an identification of the virtual partition to which the data is to be read from or written to. The volume manager uses a map associating the virtual partition to actual physical locations on the disk drive to allocate disk space. That is, the volume manager uses the map to convert software applications' read and write requests, including an identification of a virtual partition, to an I/O request including an actual physical location on the hard disk drive.

The method of FIG. 2 also includes retrieving (304), from non-volatile memory (318) by the device driver (320), information (312) describing access times for storage locations on the disk drive (170). ‘Access time,’ as the term is used in this specification refers to the time required to move a read/write head (or heads in the case of a stack of disk platters) from its current location, upon beginning execution of an I/O request, to the disk cylinder and sector where data is to be accessed for a next I/O request (‘the target sector’). Access time typically include seek time from a head's initial location to a target cylinder, settle time on the target cylinder, and rotational latency to the target sector. Seek time is the time necessary for the head to move from its initial cylinder location, upon beginning execution of an I/O request, to the cylinder where data is to be accessed for a new I/O request (‘target cylinder’). Settle time is the time required, after a seek to a target cylinder, for a head to stabilize on the target cylinder so that the head is capable of reading or writing data on the target cylinder. Rotational latency is the time required for a target sector to rotate into a position where the sector is accessible by the head. Information describing access times for storage locations on a disk drive may be unique to a particular disk drive, or a particular type of disk drive, due to physical variations between one disk drive and another.

Although access times may be expressed in terms of nano, micro, and milliseconds, access times may also be expressed in other terms. In the method of FIG. 2, for example, the information (312) describing access times for storage locations on the disk drive (170) is a table associating seek distances (326) and rotational latencies (328) for next available sectors on the disk drive. Seek distances may be expressed as a number of cylinders traversed during a seek and rotational latencies may be expressed as a number of sectors that pass under a head. Table 1 below sets forth an example implementation of the information describing access times for storage locations on the disk drive.

TABLE 1
Information Describing Access Times

| Distance (in Cylinders) | Rotational Latency (in Sectors) |
|---|---|
| 1 | 1 |
| 2 | 3 |
| 3 | 5 |
| 4 | 7 |
| 5 | 9 |
| 6 | 11 |
| 7 | 13 |
| 8 | 15 |

The example of Table 1 above includes two columns, a column representing the distance of a seek, and a column representing the rotational latency experienced during such a seek. In executing a seek traversing 4 cylinders for example, 5 sectors will pass under the head. If the current head position is at cylinder A, sector 1, a seek of four cylinders, to cylinder E, results in the next available sector being sector 6. Such information describing access times may be stored in any non-volatile memory (318) including, for example, on the disk drive itself. Information describing access times for storage locations on the disk drive may also be implemented in other ways depending upon the configuration of disk drive. One such configuration, for example, may include a disk drive configured for Zone Bit Recording (‘ZBR’). ZBR is used in disk drives to store more sectors per track on the outer tracks than on inner tracks. On a platter comprising concentric tracks, the physical track length increases with distance from the center of the platter. That is, the circumference of each track increases with distance from the center of the platter. Holding constant the storage density, the amount of data stored in a sector, the track storage capacity increases with distance from the center of the platter. That is, the outer tracks generally have more sectors then the inner tracks. Information describing access times for storage locations on the disk drive may take into account such configuration. Such information may be implemented as a table, such as a Table 2 below.

TABLE 2
Information Describing Access Times (ZBR)

| | | Rotational Latency |
|---|---|---|
| Start Cylinder | End Cylinder | (in Sectors) |
| A | B | 1 |
| A | C | 3 |
| A | D | 5 |
| A | E | 7 |
| A | F | 9 |
| A | G | 11 |
| A | H | 13 |
| A | I | 15 |

Table 2 above is similar to Table 1 above, including, as it does, a column representing rotational latencies. Table 2, however, also includes a row representing a start cylinder, the cylinder at which the head is located before executing an I/O request, and a row representing an end cylinder, the cylinder at which the head will be located after executing an I/O request. Although, Table 1 sets forth only rotational latencies for executing I/O requests beginning at cylinder A for clarity, one of skill in the art will immediately recognize that such a table will typically include rotational latencies for executing I/O requests beginning at each cylinder on the disk drive. Table 2 then takes into account any rotational latency dependencies that exist when moving a head from one track to another.

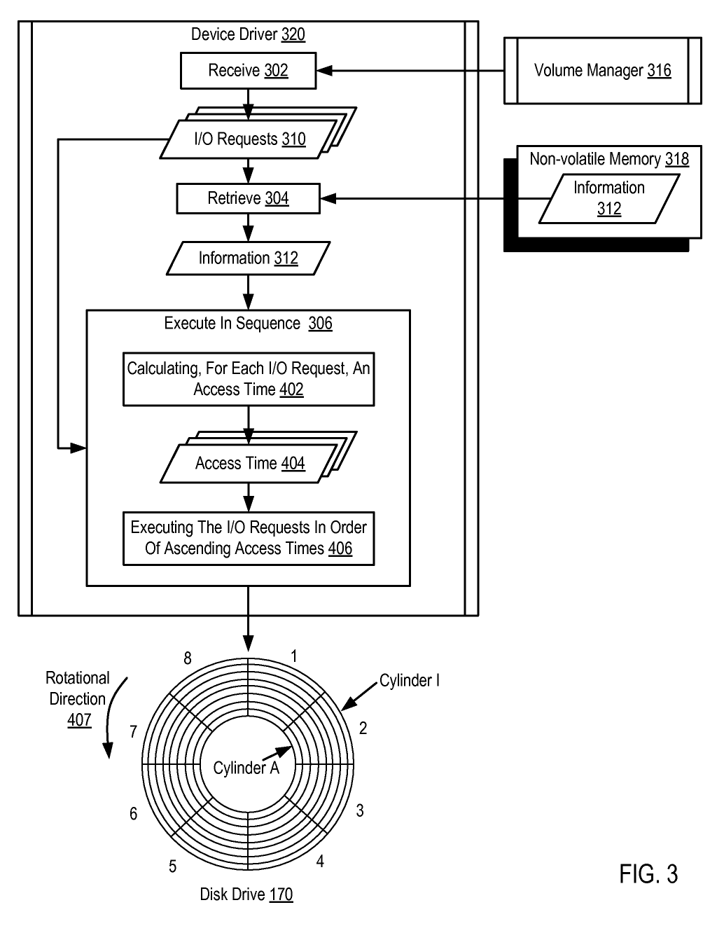

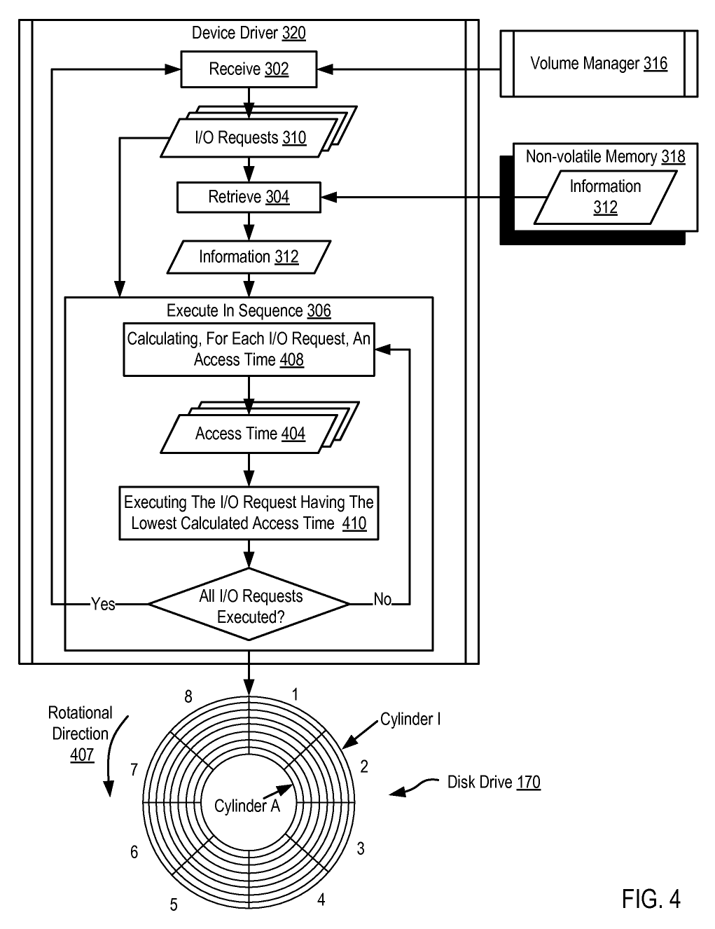

The method of FIG. 2 also includes, executing (306), by the device driver (320), the I/O requests (310) in a sequence, including identifying, in dependence upon the information (312) describing access times for storage locations on the disk drive, a sequence (314) for executing the I/O requests (310). That is, the device driver may use the information describing access times for storage locations on the disk drive to identify a sequence for executing the I/O requests and execute the I/O requests in the identified sequence. Executing I/O requests in a sequence according to embodiments of the present invention may be carried out in a number of ways. For further explanation, therefore, FIG. 3 and FIG. 4 set forth two alternative embodiments of executing I/O requests according to embodiments of the present invention.

FIG. 3 sets forth a flow chart illustrating a further exemplary method for executing I/O requests for a disk drive according to embodiments of the present invention. The method of FIG. 3 is similar to the method of FIG. 2 including, as it does, the device driver's receiving (302) a plurality of I/O requests (310), retrieving (304) information (312) describing access times for storage locations on the disk drive (170), and executing (306) the I/O requests in a sequence, all of which operate as described above. The example of FIG. 3 also includes a disk drive (170) having sectors (1-8) and cylinders (A-I). The exemplary disk drive (170) spins in a rotational direction (407), counter clockwise.

In the method of FIG. 3, executing (306) the I/O requests (310) in a sequence includes calculating (402), for each I/O request (310), an access time (404). As mentioned above, ‘access time,’ as the term is used in this specification refers to the time required to move a read/write head (or heads in the case of a stack of disk platters) from its current location, upon beginning execution of an I/O request, to the disk cylinder and sector where data is to be accessed for a next I/O request (‘the target sector’). Each of the calculated access times (404) is equal to the sum of the time required to move the head to the next available sector on the cylinder identified by the I/O request and the time required to wait from that next available sector to the target sector. That is, the calculated access time (404) represents the time required to move the head to the target sector beginning from the head's current location upon beginning execution of a next I/O request. Because the disk spins during the head's movement, a number of sectors may pass under the head while the head moves from one cylinder to another cylinder. In typical disk drives useful for executing I/O requests according to embodiments of the present invention the disk is rotating at an angular velocity such that each sector requires some characteristic amount of time to move past the head(s) which are fixed with respect to the rotation of the disk. Access time therefore may be expressed in terms of a number of sectors that will rotate past the head during the time required for the head to move to a target cylinder, settle on the target cylinder, and wait for the target sector to arrive at the head. The device driver may calculate (402) such an access time for each I/O request by, for example, using Table 1 above. Assume a head located at cylinder A, sector 1 (‘A1’) of the disk drive (170) and an I/O request identifying a location of cylinder E, sector 5 (‘E5’). For such an I/O request identifying E5, the device driver may calculate an access time equal to 12 sectors. That is, from cylinder A to cylinder E is a 4 cylinder seek distance having a 7 sector rotational latency. The next available sector on cylinder E from A1 is sector 8. After the head arrives at E8, 5 sectors will pass under the head before the target sector, sector 5, is accessible by the head.

In method of FIG. 3 executing (306) the I/O requests (310) in a sequence is also includes executing (406) the I/O requests (310) in order of ascending access times (404). That is, when the access time for each I/O request is calculated the device driver executes the I/O requests beginning with the I/O request having the shortest calculated access time and ending with the I/O request having the longest calculated access time. Consider, as an example, a head located at A1 of the disk drive (170). If the device driver receives three I/O requests identifying the locations F4, G3, and B8 the device driver may calculate an access time for F4 equal to 11, an access time for G3 equal to 12, and an access time for B8 equal to 7. The device driver may execute the I/O requests in order of ascending access times by executing the I/O request for B8, then the I/O request for F4, then the I/O request for G3. The sequence of the execution of the I/O requests, then, in this example, is B8, F4, G3.

In many cases, executing the I/O requests in ascending access time may be the most efficient way to execute I/O requests. Because the head moves during the execution of an I/O request from one location to another location, however, the device driver may execute I/O requests in a sequence more efficiently when taking into account such movement of the head during the execution of the I/O requests. For further explanation, therefore, FIG. 4 sets forth a flow chart illustrating a further exemplary method for executing I/O requests for a disk drive according to embodiments of the present invention. The method of FIG. 4 is similar to the method of FIG. 2 including, as it does, the device driver's receiving (302) a plurality of I/O requests (310), retrieving (304) information (312) describing access times for storage locations on the disk drive (170), and executing (306) the I/O requests in a sequence, all of which operate as described above. The example of FIG. 3 also includes a disk drive (170) with sectors (1-8) and cylinders (A-I). The exemplary disk drive (170) spins in a rotational direction (407), counter clockwise.

In the method of FIG. 4 executing (306) the I/O requests (310) in a sequence is carried out by, repeatedly until all the I/O requests are executed, calculating (408), for each I/O request (310), an access time (404), and executing (410) the I/O request (310) having the lowest calculated access time (404). That is, the device driver calculates, for each I/O request, an access time from the head's current location to the location identified by the I/O request, executes the I/O request having the lowest calculated access time, calculates, for each remaining I/O request, an access time from the head's new location after executing the last I/O request to the location identified by the remaining I/O request, and so on until all the I/O requests have been executed.

As an example, consider a head located at Al, and a device driver that receives three I/O requests identifying the locations F4, G3, and B8. The device driver (320) may calculate, using Table 1 above, an access time for F4 equal to 12, an access time for G3 equal to 11, and an access time for B8 equal to 7. The device driver then executes the I/O request having the lowest access time, the I/O request for B8. The device driver then calculates access times for the remaining I/O requests from the new head position, B8. The device driver calculates an access time for F4 from B8 equal to 12. That is, from cylinder B to cylinder F is a seek distance of 4, having a rotational latency of 7 sectors. The next available sector on cylinder F, from B4 is F7. Five sectors will pass under the head until the target sector, F4, is accessible by the head. The device driver also calculates an access time for G3 from B8 equal to 12. That is, from cylinder B to cylinder G is a seek distance of 5, having a rotational latency of 9 sectors. The next available sector on cylinder G from cylinder B is G1. Two sectors will pass under the head until the target sector, G3, is accessible by the head. The device driver then executes the I/O request having the lowest access time, the I/O request for B8. The device driver then executes the last I/O request, the I/O request for G3. The sequence of execution of the I/O requests is B8, G3, F4. Although only two ways of executing I/O requests in a sequence are described here, persons of skill in the art will immediately recognize that there may be many other ways to execute I/O requests in a sequence according to embodiments of the present invention, and each such way is within the scope of the present invention.

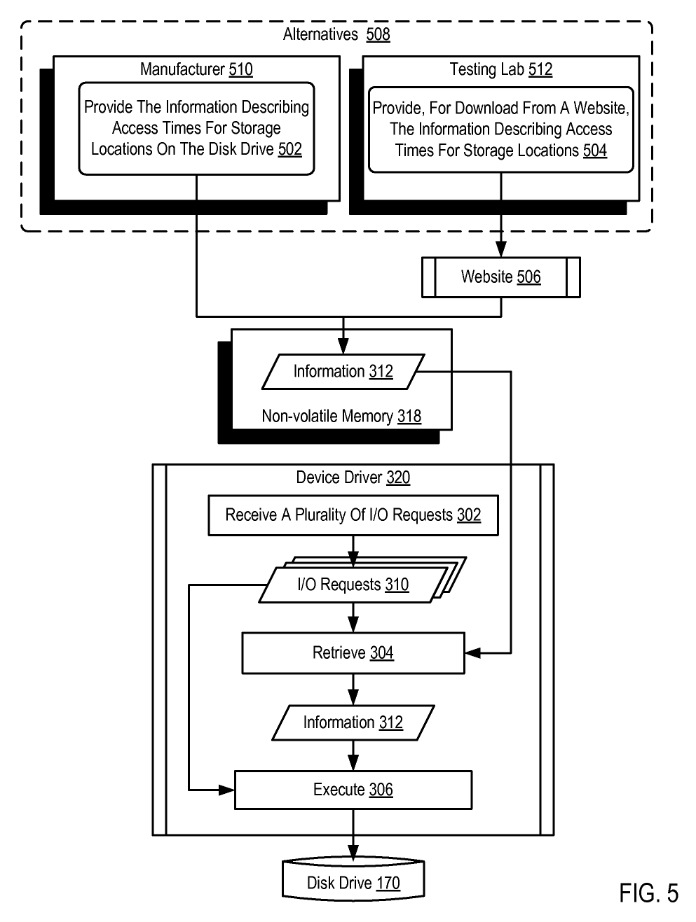

For further explanation, FIG. 5 sets forth a flow chart illustrating a further exemplary method for executing I/O requests for a disk drive according to embodiments of the present invention. The method of FIG. 5 is similar to the method of FIG. 2 including, as it does, the device driver's receiving (302) a plurality of I/O requests (310), retrieving (304) information (312) describing access times for storage locations on the disk drive (170), and executing (306) the I/O requests in a sequence, all of which operate as described above.

The method of FIG. 5, however, includes two alternatives (508) for providing the information (312) describing access times for storage locations on the disk drive. The method of FIG. 5 includes, for example, providing (502), by the manufacturer (510) of the disk drive (170), the information (312) describing access times for storage locations on the disk drive. The manufacturer may provide the information describing access times for storage locations on the disk drive in various ways including for example, as data stored on the disk drive itself, in an extensible markup language (‘XML’) document, in read only memory (ROM) connected to the disk drive, and so on as will occur to those of skill in the art.

The method of FIG. 5 also includes, as an alternative (508), providing (504), by a testing lab (512) for download from a website (506), the information (312) describing access times for storage locations on the disk drive. Testing labs may test a disk drive to determine the information describing access times for storage locations on the disk drive and make the results of the test available for download through a website. The download may be made freely available or to subscribers to the testing labs' results. Although only two ways of providing information describing access times for storage locations on the disk drive are described here, readers of skill in the art will immediately recognize that there may be many other ways to provide such information and each such way is well within the scope of the present invention.

Exemplary embodiments of the present invention are described largely in the context of a fully functional computer system for executing I/O requests for a disk drive. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of executing I/O requests for a disk drive, the method comprising:
receiving, by a device driver from a volume manager, a plurality of I/O requests;
retrieving, from non-volatile memory by the device driver, information describing access times for storage locations on the disk drive; and
executing, by the device driver, the I/O requests in a sequence, including identifying, in dependence upon the information describing access times for storage locations on the disk drive, the sequence for executing the I/O requests.

2. The method of claim 1 wherein executing the I/O requests further comprises:
calculating, for each I/O request, an access time; and
executing the I/O requests in order of ascending access times.

3. The method of claim 1 wherein executing the I/O requests further comprises repeatedly carrying out the following steps until all the I/O requests are executed:
calculating, for each I/O request, an access time; and
executing the I/O request having the lowest calculated access time.

4. The method of claim 1 wherein the information describing access times for storage locations on the disk drive comprises seek distances and rotational latencies for next available sectors on the disk drive.

5. The method of claim 1 further comprising providing, by the manufacturer of the disk drive, the information describing access times for storage locations on the disk drive.

6. The method of claim 1 further comprising providing, by a testing lab for download from a website, the information describing access times for storage locations on the disk drive.

7. Apparatus for executing I/O requests for a disk drive, the apparatus comprising a computer processor, a computer memory operatively coupled to the computer processor, the computer memory having disposed within it computer program instructions capable of:
receiving, by a device driver from a volume manager, a plurality of I/O requests;
retrieving, from non-volatile memory by the device driver, information describing access times for storage locations on the disk drive; and
executing, by the device driver, the I/O requests in a sequence, including identifying, in dependence upon the information describing access times for storage locations on the disk drive, the sequence for executing the I/O requests.

8. The apparatus of claim 7 wherein executing the I/O requests further comprises:
calculating, for each I/O request, an access time; and
executing the I/O requests in order of ascending access times.

9. The apparatus of claim 7 wherein executing the I/O requests further comprises repeatedly carrying out the following steps until all the I/O requests are executed:
calculating, for each I/O request, an access time; and
executing the I/O request having the lowest calculated access time.

10. The apparatus of claim 7 wherein the information describing access times for storage locations on the disk drive comprises seek distances and rotational latencies for next available sectors on the disk drive.

11. The apparatus of claim 7 further comprising computer program instructions capable of providing, by the manufacturer of the disk drive, the information describing access times for storage locations on the disk drive.

12. The apparatus of claim 7 further comprising computer program instructions capable of providing, by a testing lab for download from a website, the information describing access times for storage locations on the disk drive.

13. A computer program product for executing I/O requests for a disk drive, the computer program product disposed in a computer readable, signal bearing medium, the computer program product comprising computer program instructions capable of:
receiving, by a device driver from a volume manager, a plurality of I/O requests;
retrieving, from non-volatile memory by the device driver, information describing access times for storage locations on the disk drive; and
executing, by the device driver, the I/O requests in a sequence, including identifying, in dependence upon the information describing access times for storage locations on the disk drive, the sequence for executing the I/O requests.

14. The computer program product of claim 13 wherein the signal bearing medium comprises a recordable medium.

15. The computer program product of claim 13 wherein the signal bearing medium comprises a transmission medium.

16. The computer program product of claim 13 wherein executing the I/O requests further comprises:
calculating, for each I/O request, an access time; and
executing the I/O requests in order of ascending access times.

17. The Computer program product of claim 13 wherein executing the I/O requests further comprises repeatedly carrying out the following steps until all the I/O requests are executed:
calculating, for each I/O request, an access time; and
executing the I/O request having the lowest calculated access time.

18. The computer program product of claim 13 wherein the information describing access times for storage locations on the disk drive comprises seek distances and rotational latencies for next available sectors on the disk drive.

19. The computer program product of claim 13 further comprising computer program instructions capable of providing, by the manufacturer of the disk drive, the information describing access times for storage locations on the disk drive.

20. The computer program product of claim 13 further comprising computer program instructions capable of providing, by a testing lab for download from a website, the information describing access times for storage locations on the disk drive.
